(19) United States
(12) Patent Application Publication
(10) Pub. No.: US 2018/0026790 A1
(43) Pub. Date: Jan. 25, 2018

(54) EVIDENCE SYSTEM AND METHOD TO DETERMINE WHETHER DIGITAL FILE IS FORGED OR FALSIFIED BY USING SMART PHONE AND SMART PHONE HAVING CERTIFICATION FUNCTION OF SMART PHONE SCREEN CAPTURE IMAGE AND METHOD THEREOF

(71) Applicant: Republic of Korea (National Forensic Service Director Ministry of the Interior), Wonju-si, Gangwon-do (KR)

(72) Inventors: Joongseok SEO, Seoul (KR); Joong LEE, Wonju-si (KR); GiHyun NA, Wonju-si (KR); Jun-Seok BYUN, Wonju-si (KR); Kyu-Sun SHIM, Wonju-si (KR)

(73) Assignee: Republic of Korea (National Forensic Service Director Ministry of the Interior), Wonju-si, Gangwon-do (KR)

(21) Appl. No.: 15/547,924

(22) PCT Filed: Feb. 2, 2016
(86) PCT No.: PCT/KR2016/001151

§ 371 Date: Aug. 1, 2017

(30) Foreign Application Priority Data
Feb. 2, 2015 (KR) 10-2015-0016211
Apr. 17, 2015 (KR) 10-2015-0054310

(51) Int. Cl. H04L 9/32; H04L 29/06

(52) U.S. Cl. CPC H04L 9/3236; H04L 9/3226; H04L 63/12; H04L 9/3234

(57) ABSTRACT

A system and method for proving forgery of digital file using a smart phone proves whether digital file recorded as digital evidence is tampered after the digital file is created, and is used in digital forensic and criminal investigation by proving that the digital file is not forged through the forgery confirmation system, and the digital file is used for substituting for notary fee, and used as data for proving a situation in an incident, data for proving foundation works after building construction, or evidence data for voice file in a threatening case. Since content transmitting information while using smart phone is stored as digital data through screen capture and a list of applications executed before the capture is converted and stored as hash value, the digital information authentication system through smart phone screen capture confirms actual facts thereafter by proving that the corresponding content is an original copy.

### BACKGROUND OF THE INVENTION

### 1. Field of the Invention

The present invention relates to a system and method for proving forgery and tampering of a digital file, and more specifically, to a system and method for proving forgery and tampering of a digital file using a smart phone, which proposes a technique of registering important digital files (pictures, moving images, voice files and the like) in a forgery and tampering confirmation system using an electronic fingerprint (a hash value) of the digital files when the digital files are created using a smart phone in the digital forensic field and proving forgery and tampering of the digital files by the forgery and tampering confirmation system using a client-server model, provides a technique of managing from the step of creating a digital file to the step of proving forgery and tampering of the digital file using an electronic fingerprint (hash value) of the digital file, prevents forgery and tampering of the digital file through the techniques, and provides a result of determining forgery or tampering of the digital file as an evidence in case of a dispute.

The present invention relates to a digital information authentication system through smart phone screen capture and a method of authenticating a smart phone screen capture image, and more specifically, to a smart phone having a function of authenticating a smart phone screen capture image and a method of authenticating the smart phone screen capture image, which can store digital data content (pictures or chatting content) of Kakao Talk, SNS or a character message stored in the smart phone as a screen image data captured using smart phone screen capture, transmit a list of programs executed just before the capture, captured date and time and an electronic fingerprint (a hash value) of a captured screen to a server from the step of creating the captured image data to the step of authenticating the captured image data, issue an authentication ID to the smart phone by the server, and prove forgery and tampering of a digital image data captured at a later time.

### 2. Description of Related Art

When an employee of an enterprise, a bank, a security company, an insurance company, a financial institute or a company makes a contract for business or an individual makes a contract for real estates, inheritance and transfer of property, sale and purchase of a house, lease or rent, or loan, they create a contract document to establish juristic acts between the contract parties, and the interested parties sign and seal between pages of the contract document with corporation or personal stamps to carry out the juristic acts, notarize the contract document related to the juristic acts through a notary authority (a notary public law office), and keep the notarized contract documents.

FIG. 1 is a view showing conclusion and notarization of a contract between two interested parties in a conventional method.

In this case, the contract document signed by the two interested parties is kept in the cabinets or safes of the individuals or companies or document folders of the persons in charge.

However, separately keeping the contract documents in a conventional method is disadvantageous in that cost may occur to keep the documents such as contract documents, agreement documents and the like, and the documents can be forged, tampered, damaged or destroyed while keeping, and it is also difficult to search for or read a relevant document.

To improve the disadvantages, the contract documents are digitalized as a scanned document, a facsimile document, a voice data or an image data and kept as a digital file.

An electronic notary management system for contract documents is disclosed in Korea Laid-opened Patent No. 10-2007-0010771 as a prior art related to the digitalization, and the system includes a document input unit for converting and inputting a contract document as a digitalized contract document, a document notarization unit for acquiring authentication of both contract parties to notarize the digitalized contract document, a notary code creation unit for creating a notary code for the digitalized contract document on which authentication of the contract parties is completed, a document storage unit for classifying and storing the digitalized contract document according to the notary code, and a communication interface for providing a path for transmitting and receiving information with both of the contract parties through a wired or wireless communication network.

As the use of smart phone increases, digital files are used in various fields. Particularly, when a contract of an individual or a company is made, pictures or images are taken or chatting content is recorded as an evidence of the contract, and pictures of a scene at the time of an accident, pictures for confirming foundation works of a building, voice recordings against threats and the like are recorded as a digital file.

However, in case of fine forgery or tampering, traces thereof may not be found by the nature of digital files. The digital files may lose validity as an evidence due to such a characteristic. Actually, there are many cases in which digital files (pictures, moving images or voice files) are not adopted as an evidence in the court due to the problem of forgery or tampering. Contrarily, there are cases of manipulating digital files in a way advantageous to a person.

However, in the field of digital forensic, integrity of an original copy is proved through documentation in case of a digital file related to a criminal investigation. However, a document may not be a perfect alternative, and digital files created by ordinary people do not have a solution at all.

The digital files have a problem of losing effect as a digital evidence due to the possibility of forgery or tampering, which is the characteristic and also one of weak points of the digital files.

As a prior art related thereto, a ‘method of providing a photo authentication service’ is disclosed in Korean Laid-opened Patent No. 10-2014-0111143. The method of providing a photo authentication service includes the steps of: receiving an image created by a user using an application; determining whether the image is created by the application; inserting first information in the image if it is determined that the image is created by the application; and transmitting the image in which the first information is inserted to other users.

FIG. 2 is a block diagram showing a conventional image authentication service system.

An image authentication service system 1 includes a portable device 20 and a server 30.

The portable device 20 is a device having a camera, such as a digital camera, a cellular phone, a smart phone or a tablet PC. The portable device 20 includes an application capable of providing a photo authentication service. According to embodiments, the application can be referred to as an app or an application software. The application may be stored in the memory of the portable device 30.

A user may execute the application stored in the portable device 20 to provide the photo authentication service. After the application is executed, the portable device 20 may photograph an object 10 and create an image. The object 10 may be a human being. According to embodiments, the object may be a thing or an animal. In addition, the image may be referred to as a still image such as a picture or a moving image.

FIG. 3 is a view showing an embodiment of a screen of the portable device shown in FIG. 2.

Referring to FIGS. 2 and 3, a screen of the portable device 20 may be displayed as shown in FIG. 3 after the application is executed. The screen of the portable device 20 may be divided into interfaces 21 and 23. A first interface 21 displays a view of the object 10 appearing by the lens of the portable device 20. A second interface 23 may include an icon 25 while it being executed by the application.

When the user creates an image by pressing the icon 25, the created image may be transmitted to the server 30. The icon 25 is used for authentication of the image at the server 30. According to embodiments, the screen interface of the portable device 20 may be diverse. Information 33 may be inserted in the image by pressing the icon 25. When the user presses the icon 25 and the portable device 20 creates an image, the created image may be transmitted to the server 30.

According to embodiments, the server 30 may further receive data related to the image from the portable device 20. The data can be used to determine whether the image that the server 30 receives is created by the application.

FIG. 4 is a view showing an image received by the server shown in FIG. 2.

Referring to FIGS. 2 and 4, the server 30 determines whether the image received from the portable device 20 includes the information 33. The information 33 can be inserted only when the image is created by the application. The information 33 may be text or an image. When the information 33 exists in the image, the server 30 determines that the image is created by the application.

The server 30 may insert image information 31 in the image. The image information 31 may be an advertisement (AD), a logo (LOGO) or text (TEXT). The image information 31 may be provided by a user. For example, text or an image created by the user in the portable device 20 may be inserted. According to embodiments, the image information may be stored in a database 40.

The server 30 may transmit the image to at least one or more other users possessing a portable device 50 or 60. Other users may mean unspecified persons that the user does not know. The user may connect many unspecified persons interested in the image to the user by transmitting the image to the many unspecified persons.

FIG. 5 is a data flowchart of the image authentication service system shown in FIG. 2.

Referring to FIGS. 2 to 5, the server 30 receives an image that the user has created by driving an application stored in the portable device 20 (step S10).

The server 30 performs an image authentication operation (step S20). That is, the server 30 determines whether the image is created by the application. For example, the server 30 determines whether the created image includes the information 33. The information 33 may be inserted only when the image is created by the application. When the information 33 exits in the image, the server 30 determines that the image is created by the application.

According to embodiments, the server 30 may further receive data related to the image, as well as the image, from the portable device 20. The data related to the image may be an information data created at the time of creating the data or created as the application is driven. The server 30 determines whether the image is created by the application by determining whether the information data is valid. Determining whether the information data is valid means whether the server 30 receives the information data or whether the received information data is a valid data.

If the server 30 determines that the image is created by the application, the server 30 may insert the image information 31 in the image (step S30). The image information 31 may mean an advertisement (AD), a logo (LOGO) or text (TEXT). The image information 31 may be provided by a user or by the database 40 connected to the server 30.

After inserting the image information 31 in the image, the server 30 may transmit the image to other users possessing a portable device 50 or 60.

Since the server 30 transmits the image to other users, the users may trust the image created by the user.

In addition, as a prior art related thereto, a “method of preventing forgery of a document using a public key based on character recognition” is disclosed in Korean Laid-opened Patent No. 10-2009-0122657. The method relates to a document forgery prevention technique and particularly provides a document forgery prevention technique, which can guarantee content of a document by creating an electronic signature for the content of the document, in a method of recognizing the content of an offline document using a camera mounted on a mobile device such as a cellular phone, a scanner connected to a personal computer or the like and a document recognition algorithm, and additionally recording the electronic signature in the document, and in addition, it determines forgery or tampering of the document by verifying the content and the electronic signature of the document. According to the technique, an electronic signature can be made on a printed or hand-written document regardless of time and space using a mobile device having a camera, and in case of possessing an electronically signed document, forgery or tampering of the document can be conveniently confirmed on the spot only by photographing the document. Furthermore, if a certificate including an electronic signature value or a public key is printed in the form of a barcode and attached on an original document when an electronically signed document is issued, the electronic signature value can be further correctly recognized, and a receiver may easily acquire a public key.

As the use of smart phone increases, details of a contract, key business works and actual facts are transmitted and received through an application (App) such as Kakao Talk, SNS, a character message or the like using a smart phone. The pictures, dialog content or the like exchanged using the smart phone is stored through screen capture to prove actual facts in the future. However, a screen capture image of a smart phone can be easily forged or tampered thereafter, and it is difficult to prove the forgery or tampering.

Judging from the recent cases of several celebrities, many people desire to prove actual facts by capturing chatting content or evidence pictures of Kakao Talk, SNS or a character messages of a smart phone. However, although a digital data including the chatting content, the evidence pictures or the like is always under suspicion of forgery and tampering since it can be edited to be advantageous to a person opening the data, fine forgery or tampering of the digital data may not be found by the nature of digital data.

### SUMMARY OF THE INVENTION

The solve the problems, the present invention proposes a system and technique for managing from the step of creating an important digital file such as a contract document, a juristic act document or the like to the step of proving forgery and tampering of the document using an electronic fingerprint (a hash value) on the basis of a client-server model in the digital forensic field, and an object of the present invention is to provide a system and method for proving forgery and tampering of a digital file using, a smart phone, which provide a technique of managing, using an electronic fingerprint (a hash value) of the digital file, the steps of: calculating a primary electronic fingerprint (a hash value) of the digital file from the digital file (a picture, a moving image or a voice) of a picture, a moving image or a voice file photographed or recorded by a target terminal (a smart phone) using a client program of the target terminal (a smart phone or a tablet PC); registering the photographed/recorded digital file, the calculated electronic fingerprint, terminal information (a cellular phone number), GPS position info nation of the terminal, meta data and a user key value in the forgery and tampering confirmation system; creating and storing a secondary electronic fingerprint using a manager key (key2); proving forgery or tampering of a digital file after the digital file is created; and sharing the information registered in the forgery and tampering confirmation system among contract parties using a local area network.

In addition, another object of the present invention is to provide a smart phone having a function of authenticating a smart phone screen capture image and a method of authenticating the smart phone screen capture image when; it is desired to store an important digital data (a picture or dialog content) through screen capture from the time point of capturing the digital data while using Kakao Talk, SND or character message in a smart phone, which can store digital data content (pictures or chatting, content) of Kakao Talk, SNS or a character message stored in the smart phone as a screen image data captured using smart phone screen capture, transmit a list of programs executed just before the capture captured date and time and electronic fingerprints (hash values) of the captured screens to a server from the step of creating the captured image data to the step of authenticating the captured image data, issue an authentication ID to the smart phone by the server, and prove forgery and tampering of a digital image data captured at a later time.

The technique proposed in the present invention can prove whether a captured screen is in an original form after a user captures the screen from a smart phone. When a screen is captured from a smart phone, an electronic fingerprint (a hash value) is calculated by combining information on the programs executed just before the capture, the captured date and time and the captured screen data. The smart phone transmits the calculated electronic fingerprint (a hash value) or the electronic fingerprint (a hash value) and the captured screen data to the forgery and tampering confirmation system server. The forgery and tampering confirmation system server may prove an original copy of the digital data by issuing an authentication ID for the received data (the electronic fingerprint or the electronic fingerprint and the captured screen) and publicizing an electronic fingerprint for the entire data of a specific unit (a day unit) of the transmitted data on an open medium (a newspaper or a homepage).

To accomplish an object of the present invention, there is provided a system for proving forgery and tampering of a digital file using a smart phone, the system including: at least one or more target terminals provided with a client program for transmitting a photographed and/or recorded digital file, a primary electronic fingerprint (a hash value) of the digital file, terminal information, position information at the time of digital file creation, meta data and a user key (key1) and receiving an authentication ID in response thereto; and a forgery and tampering confirmation system for converting and storing the received information except the user key (key1) (the digital file, the primary electronic fingerprint, the terminal information, the position information at the time of file creation and the meta data) in a DB form, issuing and storing the authentication ID by creating a secondary electronic fingerprint (a hash value) by combining the information converted in a DB form with a manager key (key2), transmitting the authentication ID to the clients of the at least one or more target terminals, receiving a digital file of which the forgery or tampering is desired to be confirmed, the authentication ID, the primary electronic fingerprint and the terminal information from the client of the target terminal when forgery or tampering of the digital file is to be proved, determining forgery or tampering of the digital file by comparing the received information with an authentication ID, an electronic fingerprint and terminal information stored in a database, and transmitting a result of determining forgery or tampering of the digital file to the client of the target terminal.

To accomplish an object of the present invention, there is provided a smart phone having a function of authenticating a smart phone screen capture image, the smart phone including: a control unit; a smart phone storage unit connected to the control unit; a display unit connected to the control unit; and an input means connected to the control unit, wherein a hash algorithm and one or more applications are stored and driven in the smart phone storage unit, and if a screen capture command is input by a user through the input unit, a screen is captured and stored in the smart phone storage unit as an image, and an image data is created as a hash value by a hash algorithm and stored in the smart phone storage unit.

To accomplish another object of the present invention, there is provided a method of authenticating a smart phone screen capture image, the method being executed in a forgery and tampering confirmation server configured of a smart phone and a forgery and tampering confirmation system server communicating with the smart phone to authenticate the smart phone screen capture image, wherein the smart phone includes: a control unit; a smart phone storage unit connected to the control unit; a display unit connected to the control unit; and an input means connected to the control unit, wherein a hash algorithm and one or more applications are stored in the smart phone storage unit, and the forgery and tampering confirmation system server includes: a control unit; a server storage unit connected to the control unit; and a forgery and tampering, confirmation unit for issuing an authentication ID and confirming forgery and tampering of the smart phone screen capture image, wherein a hash algorithm is stored and driven in the server storage unit, the method comprising a smart phone screen capture step and a captured image authentication step, wherein the smart phone screen capture step includes: a capture image storage step of capturing a screen and storing a captured image data in the smart phone storage unit as a screen capture command is input by a user through the input unit; a first hash value storage step of creating the image data as a hash value using a hash algorithm and storing, the hash value in the smart phone storage unit; a first transmission step of transmitting the hash value stored in the smart phone storage unit to the forgery and tampering confirmation system server; an authentication data storage step of creating an authentication ID by encrypting the transmitted hash value using an authentication key and storing the authentication ID in the server storage unit, together with the hash value, by the forgery and tampering confirmation system server; and an authentication ID transmission and storage step of transmitting the authentication ID to the smart phone and storing the authentication ID in the smart phone storage unit, and the captured image authentication step includes: a second transmission step of transmitting the hash value created from the smart phone capture image data stored in the smart phone storage unit using a hash value algorithm to the forgery and tampering confirmation system server, together with the authentication ID stored in the smart phone storage unit, and storing the hash value and the authentication ID in the server storage unit; and a hash value comparison step of searching for an authentication ID the same as the authentication ID received from the smart phone from the server storage unit and comparing the received hash value with the hash value stored in the server storage unit.

### Advantageous Effects

According to the present invention as described above, the system and method for proving forgery and tampering of a digital file using a smart phone may clearly prove whether a digital file photographed or recorded as a digital evidence is forged or tampered after the digital file is created. Actually, although the digital file may lose effect as an evidence due to fine forgery or tampering, it also can be used in the digital forensic field, a criminal investigation or a dispute between individuals or enterprises by proving that the digital file is not forged or tampered through the proposed forgery and tampering confirmation system.

In addition, the digital file can be used as a means for substituting for a notary fee, a notary problem or the like which may occur in making a contract and also can be used as a data for proving a situation in case of being involved in an incident or an accident, a data for proving foundation works after construction of a building, or a clear evidence data for a voice file in a threatening case.

In addition, according to the present invention as described above, since content frequently transmitting and receiving important personal information (pictures, chatting content and the like) and determined as needed while using Kakao Talk, SNS or a character message in a smart phone is stored as a digital data through screen capture and a list of applications executed just before the capture is also converted and stored as a hash value, the digital information authentication system through smart phone screen capture may confirm actual facts thereafter by proving that the corresponding content is an original copy. Actually, although a digital data may lose effect as an evidence due to fine forgery or tampering, it can be used in a criminal investigation or a dispute between individuals or enterprises by proving that the digital data is not forged or tampered using the digital information authentication system through smart phone screen capture. According to the digital information authentication system through smart phone screen capture and a method thereof according to the present invention, since it can be clearly proved that the image is captured from a screen of an application executed just before the capture, there is an effect of fundamentally preventing forgery and tampering of the captured image.

### BRIEF DESCRIPTION OF THE DRAWINGS

FIG. 1 is a view showing conclusion and notarization of a contract between two interested parties in a conventional method.

FIG. 2 is a block diagram showing a conventional image authentication service system.

FIG. 3 is a view showing an example of a screen of the portable device shown in FIG. 2.

FIG. 4 is a view showing an image received by the server shown in FIG. 2.

FIG. 5 is a view data flow of the image authentication service system shown in FIG. 2.

FIGS. 6 and 7 are views showing a process performed by a client program of a target terminal (a smart phone or a tablet PC) and a forgery and tampering confirmation system when a digital file is created and forgery and tampering of the digital file is proved.

FIG. 8 is a view showing the configuration of a system for proving forgery and tampering of a digital file using a smart phone according to an embodiment of the present invention.

FIG. 9 is a flowchart illustrating a method of proving forgery and tampering of a digital file using a smart phone according to the present invention.

FIG. 10 is a view showing the configuration of a smart phone and a forgery and tampering confirmation system for embodying the present invention.

FIG. 11 is a view schematically showing a display window of Kakao Talk executed in a smart phone.

FIG. 12 is a flowchart illustrating the order of executing storage of an image capturing a smart phone window.

FIG. 13 is a view showing a process of transmitting an image data captured from a smart phone, program information and an electronic fingerprint value (a hash value) to a forgery and tampering confirmation system server and issuing an authentication ID to the smart phone by the forgery and tampering confirmation system when a screen is captured.

FIG. 14 is a view showing a process of creating an electronic fingerprint (a hash value) for authentication using information on a captured screen (a captured screen image data, a list of programs executed just before the capture, and a captured date) and transmitting a selected authentication electronic fingerprint (a hash value) and an authentication ID to a forgery and tampering confirmation system server by a smart phone application when forgery or tampering of the image data is proved.

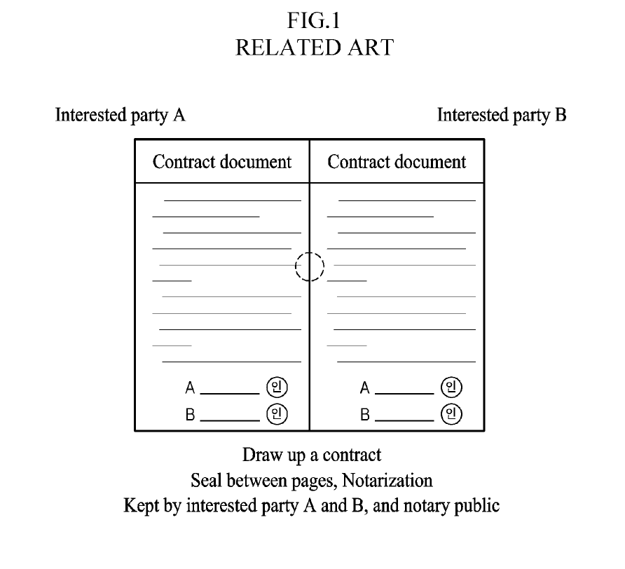

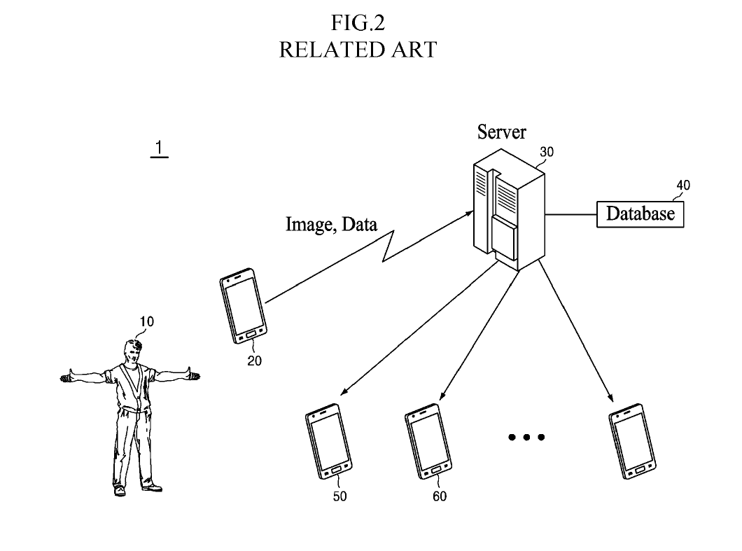

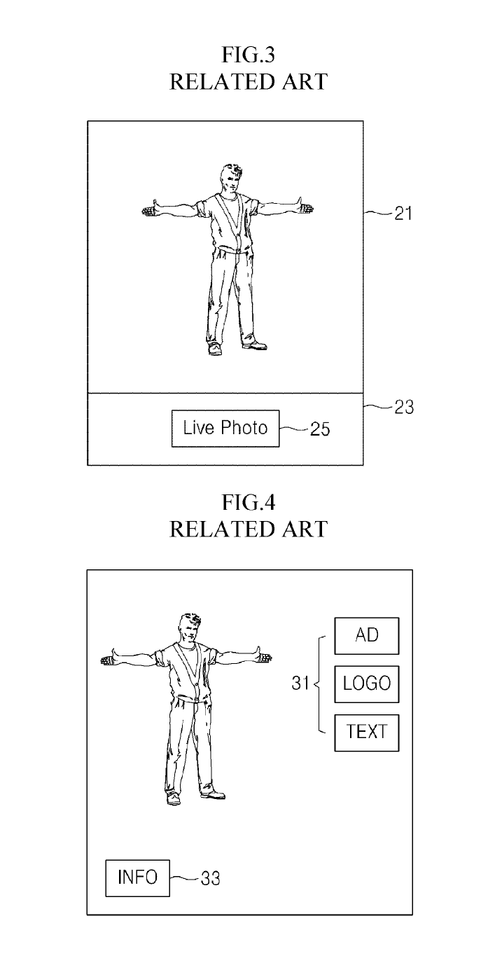

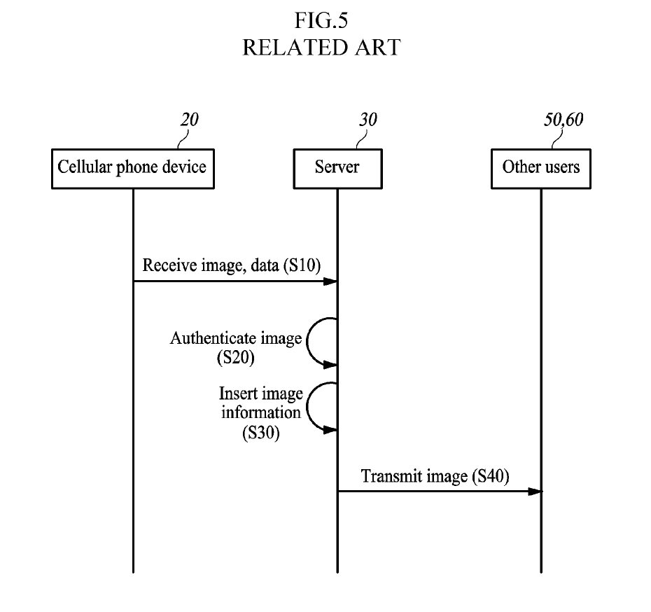

### DETAILED DESCRIPTION OF THE INVENTION

The objects, features and advantages of the present invention will be further clarified from the following detailed descriptions and the preferred embodiments made with reference to the accompanying drawings. In assigning reference numerals to the constitutional components of each drawing of this specification, the same reference numerals are assigned to the same constitutional components if possible although they are shown on different drawings. In addition, although the terms such as “first”, “second” and the like can be used for describing various constitutional components, the constitutional components are not limited by the terms. The terms are used only to distinguish a constitutional component from the other constitutional components. In addition, in describing the present invention, when it is determined that the detailed description of the known art related to the present invention may unnecessarily obscure the gist of the present invention, the detailed description thereof will be omitted.

Hereinafter, preferred embodiments of the present invention will be described in detail with reference to the accompanying drawings.

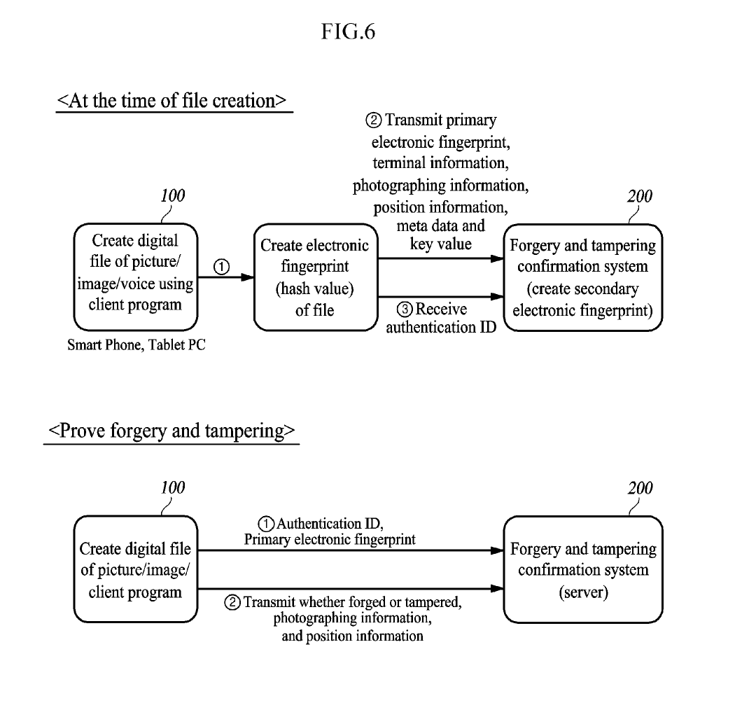

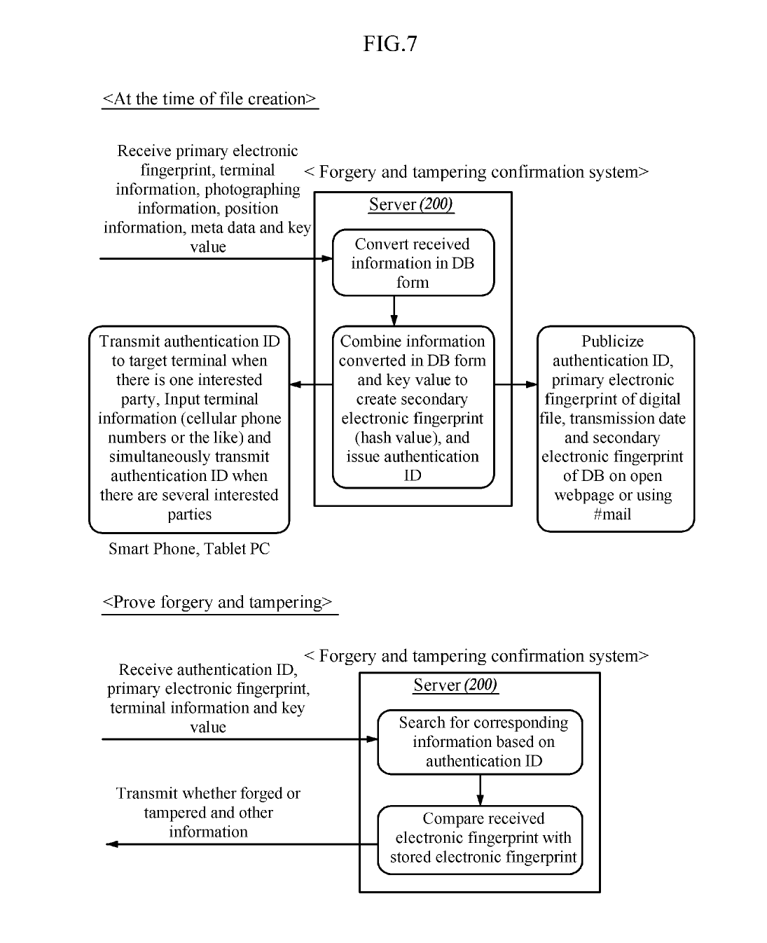

FIGS. 6 and 7 are views showing a process performed by a client program of a target terminal (a smart phone or a tablet PC and a forgery and tampering confirmation system when a digital file is created and forgery or tampering is proved.

The present invention proposes a technique of registering a digital file (a photographed or recorded picture, a moving image or a voice file) in a forgery and tampering confirmation system using an electronic fingerprint (a hash value) when the digital file is created using a smart phone and proving forgery or tampering of the digital file by the forgery and tampering confirmation system.

Any one of terminals including a smart phone, a mobile communication terminal, a tablet PC, a handheld device and a wearable device (a smart watch, a wristwatch-type smart phone) may be used as a target terminal 100. Although a smart phone is described as an example in an embodiment of the present invention, it is not limited thereto.

When a digital file is created, after a primary electronic fingerprint is calculated for the digital file created by the target terminal (e.g., a smart phone), the photographed and/or recorded digital file, the calculated primary electronic fingerprint, terminal information, position information (GPS position information) at the time of initial registration, meta data and a user key are transmitted to the forgery and tampering confirmation system. The forgery and tampering confirmation system issues an authentication ID to the smart phone, recalculates an electronic fingerprint (a hash value) combined with the received data and stores the recalculated electronic fingerprint in a database.

The authentication ID issued to the target terminal (e.g., a smart phone) by the forgery and tampering confirmation system is shared among the target terminal (a smart phone) and terminals (smart phones) of contract parties—if there are terminals of the contract parties—to confirm that the digital file is registered in the forgery and tampering confirmation system, and the forgery and tampering confirmation system proposes a technique of confirming forgery and tampering of a digital file by publicizing the authentication ID, the digital file, the electronic fingerprint of the digital file and the transmission date and time on the homepage.

A system for proving forgery and tampering of a digital file using a smart phone provides a technique of confirming forgery and tampering by applying an electronic fingerprint (a hash value) using a client-server model together with the target terminal (e.g., a smart phone).

The client side of the target terminal (e.g., a smart phone) should be a device which can confirm personal information, GPS position information and time information like a general smart phone.

FIG. 6 is a view showing a process of creating a digital file and proving forgery and tampering of the digital file by the client program of the target terminal (a smart phone or a tablet PC) and the forgery and tampering confirmation system at the client side.

As shown in FIG. 6, a technique of proving forgery and tampering using an electronic fingerprint of a digital file of the client side proposed to a corresponding target terminal is described.

First, when a digital file is created, 1) a picture, a moving image or a voice file for proving a juristic act or a contract status is created using a client program of the target terminal.

2) A primary electronic fingerprint (a hash value) of the file created by the client program of the target terminal is created.

hash_value=hash(char*key): Apply hash algorithm

3) The created digital file, the primary electronic fingerprint, terminal information, position information, meta data and a user key (key1) value are transmitted from the client program of the target terminal to the forgery and tampering confirmation system.

4) After the forgery and tampering confirmation system receives information on the digital file from the client program of the target terminal, the steps of the client performed when the file is created are terminated as the client program of the target terminal receives, from the forgery and tampering confirmation system, that the information has been transmitted.

Next, when forgery or tampering is to be proved, 1) the client program of the target terminal selects a digital file of which the forgery or tampering is desired to be confirmed.

2) The primary electronic fingerprint of the selected digital file, an authentication ID and terminal information are transmitted to the forgery and tampering confirmation system.

3) The forgery and tampering confirmation system determines forgery or tampering by comparing the authentication ID and the primary electronic fingerprint with the authentication ID and the primary electronic fingerprint stored when the authentication ID and the primary electronic fingerprint are registered in the DB and transmits a result of determining forgery or tampering to the client of the target terminal, together with a corresponding photographed and/or recorded digital file and position information at the time of file creation.

The client program of the target terminal creates an electronic fingerprint when a digital file is created and transmits terminal information to the forgery and tampering confirmation system based on the Privacy Protection Act in the sequence as described above, and when forgery or tampering of the digital file is to be proved, if the target terminal transmits the authentication ID received when the digital file is created and the primary electronic fingerprint to the forgery and tampering confirmation system, the forgery and tampering confirmation system determines forgery or tampering of the digital file by creating a secondary electronic fingerprint using a manager key (key2) on the received primary electronic fingerprint and comparing the authentication ID, the primary electronic fingerprint and the secondary electronic fingerprint with the authentication ID, the primary electronic fingerprint and the secondary electronic fingerprint stored in the DB and may prove forgery or tampering of the digital file by transmitting a result of determining forgery or tampering of the digital file, position information at the time of registration and the like to the target terminal.

FIG. 7 is a view showing the process of creating a digital file and proving forgery and tampering of the digital file by the client program of the target terminal (a smart phone or a tablet PC) and the forgery and tampering confirmation system at the server side.

The server side provides a service of determining and proving forgery or tampering of a digital file by comparing the data created and transmitted from the client program of the target terminal (a smart phone or a tablet PC) with the authentication ID and the electronic fingerprints of the digital file as shown in FIG. 7.

First, when a file is created by the client of the target terminal, 1) the forgery and tampering confirmation system (server) receives a photographed and/or recorded digital file, a primary electronic fingerprint, terminal information, position information, meta data and a user key (key1) transmitted from the client program of the target terminal and converts and stores the information except the user key (key1) (the digital file, the primary electronic fingerprint, the terminal information, the position information and the meta data) in a DB form.

2) Then, the information converted in a DB form is converted and created as a secondary electronic fingerprint, together with a manager key (key2). The prim electronic fingerprint created by the client is stored in the database (DB), and the secondary electronic fingerprint is additionally created and stored using the DB fields and the manager key (key2).

3) The authentication ID, the created digital file, the primary electronic fingerprint of the digital file, information on the transmission date and time of the digital file, the terminal information and the secondary electronic fingerprint created using the manager key (key2) are publicized on an open webpage or using a #mail, and thus suspicion of manipulation on the digital file made in the system in the future can be relieved.

When forgery or tampering of the digital file is to be proved, 1) the client of the target terminal transmits the authentication ID, the primary electronic fingerprint, the terminal information (when the terminal is not changed) and the user key (key 1) to the forgery and tampering confirmation system.

2) The forgery and tampering confirmation system primarily confirms whether the received primary electronic fingerprint accords to a primary electronic fingerprint recorded in the DB by searching for stored information using the authentication ID and comparing the electronic fingerprints, creates a secondary electronic fingerprint of the received primary electronic fingerprint using the information stored in the DB and the manager key (key2), compares the secondary electronic fingerprint with a previously publicized secondary electronic fingerprint, finally determines that the digital file is not forged or tampered if the secondary electronic fingerprint accords to the previously publicized secondary electronic fingerprint, and transmits a result of determining forgery or tampering of the digital file, the terminal information, the photographed date, the position information at the time of registration and meta data information to the client of the target terminal.

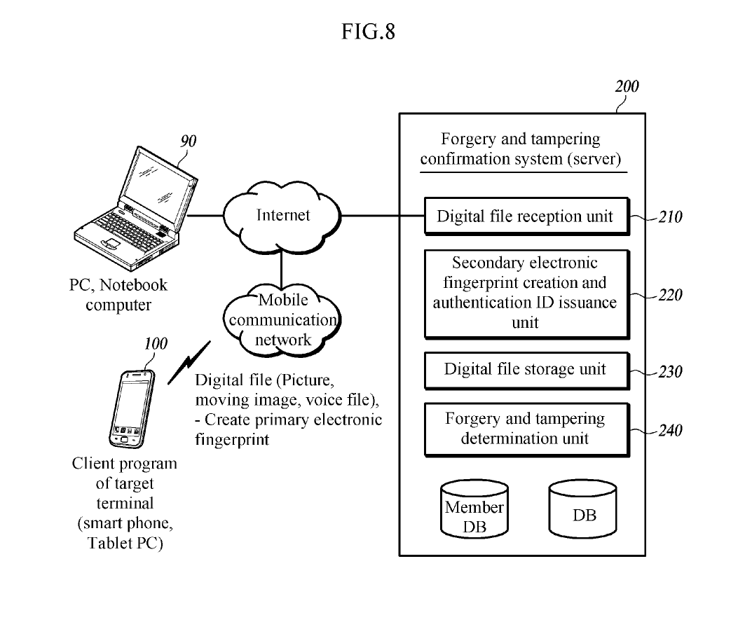

FIG. 8 is a view showing the configuration of a system for proving forgery and tampering of a digital file using a smart phone according to an embodiment of the present invention.

A system for proving forgery and tampering of a digital file using a smart phone is configured of a target terminal 100 installed with a client program and a forgery and tampering confirmation system 200.

Any one of terminals including a smart phone, a mobile communication terminal, a tablet PC, a handheld device and a wearable device (a smart watch, a wristwatch-type smart phone) may be used as a target terminal 100.

The forgery and tampering confirmation system 200 includes a digital file reception unit 210, a secondary electronic fingerprint creation and authentication ID issuance unit 220, a digital file storage unit 230, a forgery and tampering determination unit 240, a member DB and a database.

A system for proving forgery and tampering of a digital file using a smart phone includes: at least one or more target terminals 100 provided with a client program for transmitting a photographed and/or recorded digital file (a picture, a moving image or a voice file), a primary electronic fingerprint (a hash value) of the digital file, terminal information, position information at the time of digital file creation, meta data and a user key (key1) to be registered and stored and receiving an authentication ID from a forgery and tampering confirmation system 200 in response thereto; and the forgery and tampering confirmation system 200 for converting and storing the received information except the user key (key1) (the digital file, the primary electronic fingerprint, the terminal information, the position information at the time of file creation and the meta data) in a DB form, issuing and storing the authentication ID by creating a secondary electronic fingerprint (a hash value) by combining the information converted in a DB form with a manager key for authentication (key2), transmitting the authentication ID to the clients of the at least one or more target terminals 100, receiving a digital file of which the forgery or tampering is desired to be confirmed, the authentication ID, the primary electronic fingerprint and the terminal information from the client of the target terminal when forgery or tampering of the digital file is to be proved, determining forgery or tampering of the digital file by comparing the received information with the authentication ID, the electronic fingerprint and the terminal information stored in the database, and transmitting a result of determining forgery or tampering of the digital file to the client of the target terminal.

When forgery or tampering of the digital file is to be proved, the forgery and tampering confirmation system 200 receives a digital file of which the forgery or tampering is desired to be confirmed, the authentication ID, the primary electronic fingerprint and the terminal information from the client of the target terminal 100, converts and stores the primary electronic fingerprint, the terminal information, the position information at the time of file creation and the meta data in a DB form, creates a secondary electronic fingerprint of the digital file, the forgery or tampering of which is desired to be confirmed, by combining the information converted in a DB form with the manager key (key2), compares the authentication ID, the secondary electronic fingerprint and the terminal information with the authentication ID, the secondary electronic fingerprint and the terminal information previously stored in the database. If they are the same, the forgery and tampering confirmation system 200 transmits a result of determining forgery or tampering of the digital file, which proves that the digital file is an original copy, to the client of the target terminal 100.

If the authentication ID, the secondary electronic fingerprint and the terminal information are not the same as those stored in the database, the forgery and tampering confirmation system 200 transmits a result of determining forgery or tampering of the digital file, which shows that the digital file is forged or tampered, and the digital file photographed and recorded at the time of initial registration to the client of the target terminal 100.

The forgery and tampering confirmation system 200 includes: a digital file input unit 210 for receiving a photographed and/or recorded digital file, a primary electronic fingerprint (a hash value) of the digital file, terminal information (a cellular phone number), position information at the time of file creation, meta data and a user key (key1) from the client of the target terminal 100; a secondary electronic fingerprint creation and authentication ID issuance unit 220 for converting the received information except the user key (the photographed and/or recorded digital file, the primary electronic fingerprint, the terminal information, the position information at the time of file creation and the meta data) in a DB form, issuing an authentication ID by recalculating the secondary electronic fingerprint (a hash value) using the information converted in a DB form and a manager key (key2), and transmitting the authentication ID to the client of the target terminal 100; a digital file storage unit 230 for storing the photographed and/or recorded digital file, the primary electronic fingerprint (a hash value) of the digital file, the terminal information (a cellular phone number), the position information at the time of file creation, the meta data, the secondary electronic fingerprint and the authentication ID; a forgery and tampering determination unit 240 for determining forgery or tampering of a corresponding digital file by confirming the authentication ID, the primary electronic fingerprint and the terminal information received from the client of the target terminal 100 when forgery or tampering of the digital file is to be proved, and transmitting the digital file stored in the DB at the time of initial registration and position information at the time of digital file creation to the client of the target terminal 100, together with a result of determining forgery or tampering of the digital file; a member database; and a database for storing the photographed and/or recorded digital file transmitted from the client of the target terminal 100, the primary electronic fingerprint (a hash value) of the digital file, the terminal information (a cellular phone number), the position information at the time of file creation, the meta data, the secondary electronic fingerprint and the authentication ID.

The photographed and/or recorded digital file is a photographed picture or moving image or a recorded voice file for proving a status of a juristic act such as conclusion of a contract or the like among at least two or more contract parties.

The meta data includes a content ID, a file name, a content type, information on the transmission date and time of the digital file at the time of registration and information on the copyright holder who has created the digital file.

The primary electronic fingerprint and the secondary electronic fingerprint (hash values) are created from the user key (key1) and the manager key (key2) using the MD-5 or SHA-1 hash algorithm.

For reference, the MD-5 (Message-Digest algorithm 5) algorithm creates a hash value of 128 bits (16 bytes or 4 words) for 512-bit message blocks of a character string.

The user key (key1) creates a first electronic fingerprint of the digital file by creating a hash value using a hash algorithm in the client of the target terminal (a smart phone).

The manager key (key2) creates a second electronic fingerprint by creating a hash value using a hash algorithm in the forgery and tampering confirmation system (server).

Since the client of the target terminal 100 creates the first electronic fingerprint of the digital file from the user key (key1) using the MD-5 or SHA-1 hash algorithm and the forgery and tampering confirmation system 200 recalculates the second electronic fingerprint using the manager key (key2), a double hash value is applied.

The authentication ID is stored in both of the target terminal and the forgery and tampering confirmation system, whereas the authentication ID, the digital file and the first electronic fingerprint are stored in the target terminal, and the authentication ID, the digital file, the first electronic fingerprint, the second electronic fingerprint, the terminal information, the meta data (e.g., the file registration date and time) and the key values are stored in the forgery and tampering confirmation system.

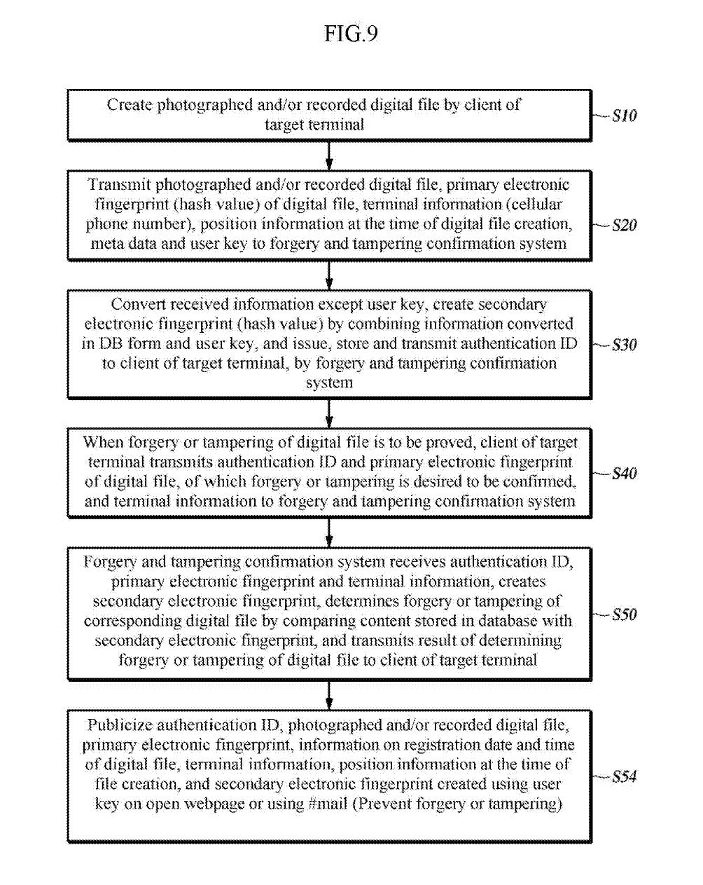

FIG. 9 is a flowchart illustrating a method of proving forgery and tampering of a digital file using a smart phone according to the present invention.

A method of proving forgery and tampering of a digital file using a smart phone includes the steps of: (a) when a digital file is created, receiving, after a photographed and/or recorded digital file (a picture, a moving image or a voice file) is created by a client of at least one or more target terminals 100 (step S10), the photographed and/or recorded digital file, a primary electronic fingerprint (a hash value) of the digital file, terminal information, position information at the time of file creation, meta data and a user key (key1) from the client of the at least one or more target terminals 100, by the forgery and tampering confirmation system 200 (step S20); (b) converting and storing the received information except the user key (key1) in the database, issuing and storing an authentication ID by recalculating a secondary electronic fingerprint (a hash value) by combining the information converted in a DB form with the manager key (key2), and transmitting the authentication ID to the client of the at least one or more target terminals 100, by the forgery and tampering confirmation system 200 (step S30); (c) when forgery or tampering of a digital file is to be proved, receiving the authentication ID, the primary electronic fingerprint of the digital file of which the forgery or tampering is desired to be confirmed, and the terminal information from the client of the target terminal 100, by the forgery and tampering confirmation system 200 (step S40); and (d) determining forgery or tampering of the corresponding digital file by comparing the authentication ID, the primary electronic fingerprint and the terminal information with the primary electronic fingerprint stored in the database and transmitting a result of determining forgery or tampering of the digital file, showing a proof of an original copy or forgery or tampering of the digital file, to the client of the target terminal 100, by the forgery and tampering confirmation system 200.

At step (b), the photographed and/or recorded digital file transmitted from the client of the target terminal 100, the primary electronic fingerprint (a hash value) of the digital file, the terminal information (a cellular phone number), the position information at the time of digital file creation, information on the transmission date and time of the digital file, the secondary electronic fingerprint and the authentication ID are stored in the database of the forgery and tampering confirmation system 200.

After the information is stored in the forgery and tampering confirmation system 200, the authentication ID, the digital file and the primary electronic fingerprint are stored and kept in the target terminals 100 of the contract parties through wired or wireless communication or short range communication (Bluetooth or ZigBee).

The primary electronic fingerprint and the secondary electronic fingerprint (hash values) are created from the user key (key1) and the manager key (key2) using the MD-5 or SHA-1 hash algorithm.

Since the client of the target terminal 100 creates the first electronic fingerprint of the digital file from the user key (key1) using the MD-5 or SHA-1 hash algorithm and the forgery and tampering confirmation system 200 recalculates the second electronic fingerprint using the manager key (key2), a double hash value is applied.

The authentication ID is stored in both of the target terminal and the forgery and tampering confirmation system, whereas the authentication ID, the digital file and the first electronic fingerprint are stored in the target terminal, and the authentication ID, the digital file, the first electronic fingerprint, the second electronic fingerprint, the terminal information, the meta data (e.g., the file registration date and time) and the key values are stored in the forgery and tampering confirmation system.

When forgery or tampering of a digital file is to be proved, the method of the forgery and tampering confirmation system 200 further includes the step of primarily confirming whether the received primary electronic fingerprint accords to the primary electronic fingerprint recorded in the DB by searching for stored information using the authentication ID and comparing the electronic fingerprints, creating a secondary electronic fingerprint using the information received and stored when confirmation of forgery or tampering is requested and the manager key (key2), comparing the secondary electronic fingerprint with a previously publicized secondary electronic fingerprint, finally determining that the digital file is not forged or tampered if the secondary electronic fingerprint accords to the previously publicized secondary electronic fingerprint, and transmitting a result of determining forgery or tampering of the digital file, the terminal information, the photographed date, the position information at the time of registration and meta data information to the client of the target terminal 100.

The method further includes the step of (e) preventing, after transmitting the authentication ID to the target terminal, manipulation of the digital file in the system in the future by publicizing the authentication ID, the digital file, the primary electronic fingerprint, information on the transmission date and time of the digital file, the terminal information, the position information at the time of file creation and the secondary electronic fingerprint created using the manager key on an open webpage or using a #mail (step S54).

The method of the present invention as described above may be implemented as a program and stored in a recording medium (CD-ROM, RAM, ROM, a memory card, a hard disk, an optical magnetic disk, a storage device or the like) in a form readable using software of a computer.

The smart phone having a function of authenticating a smart phone screen capture image and an authentication method thereof proposed in the present invention may prove whether an image of a screen captured by a user from a smart phone is an original copy. When the screen is captured, the smart phone calculates an electronic fingerprint (a hash value) by combining information on the programs executed just before the capture, the captured date and time and the captured screen data. The smart phone transmits the calculated electronic fingerprint (a hash value) or the electronic fingerprint (a hash value) and the captured screen data to the forgery and tampering confirmation system. The forgery and tampering confirmation system may prove an original copy of the digital data by issuing an authentication ID for the received data (the electronic fingerprint or the electronic fingerprint and the captured screen) and publicizing an electronic fingerprint for the entire data of a specific unit (a day unit) of the transmitted data on an open medium (a newspaper or a homepage).

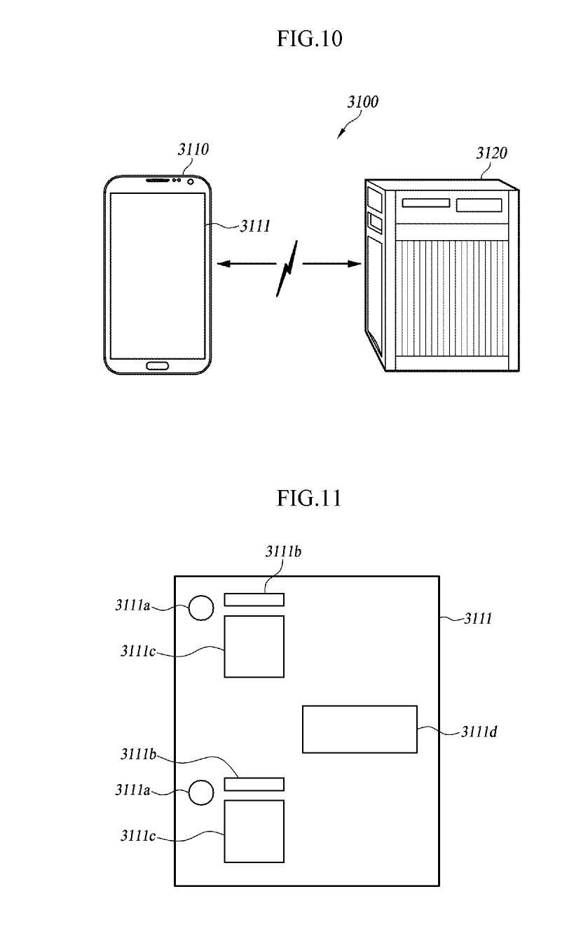

As shown in FIG. 10, the system for proving forgery and tampering of a smart phone capture image according to the present invention is configured of a smart phone 3110 having a function of authenticating a smart phone screen capture image (hereinafter, referred to as a ‘smart phone’) and a forgery and tampering confirmation system server 3120.

The smart phone 3110 specified in the present invention means a terminal having a screen capture function and a network function, which is configured of a control unit, a smart phone storage unit connected to the control unit, a display unit 3111 connected to the control unit, and an input means connected to the control unit, in which a hash algorithm and one or more applications are stored and driven in the smart phone storage unit. In the smart phone 3110 having a function of authenticating a smart phone screen capture image according to the present invention, a program for calculating and storing, when a user inputs a screen capture command through the input unit, a hash value using a captured screen image data and information on the applications executed just before the input of the screen capture command (hereinafter, referred to as an ‘execution application’) is stored and executed in the smart phone storage unit.

Content of a digital data of a captured screen (a picture or a captured chatting content screen) that the user desires to authenticate is transmitted from the smart phone 3110 through the data flow as shown in FIG. 14 and proved to be an original copy.

A method of authenticating a smart phone screen capture image according to the present invention is executed in the forgery and tampering confirmation system 3100 for authenticating a smart phone screen capture image, in which the forgery and tampering confirmation system includes the smart phone 3110 and the forgery and tampering confirmation system server 3120 communicating with the smart phone, and the method of authenticating a smart phone screen capture image includes a smart phone screen capture step and a captured image authentication step.

When a screen including pictures or chatting content of Kakao Talk, SNS, a character message or the like is captured from the smart phone 3110, (1) if the user of the smart phone 3110 inputs a command for capturing a screen of the smart phone 3110, i.e., a screen (dialog content, a picture or the like) to be proved, into the input unit, (2) the execution application creates an electronic fingerprint (a hash value; a first hash value) by combining the image data of the captured screen with information on the programs executed just before the screen capture. The created electronic fingerprint (a hash value; a first hash value) is stored in the smart phone storage unit. The captured date and time may be further included, together with the information on the programs executed just before the screen capture, to be created as the electronic fingerprint (a hash value; a first hash value).

The programs executed just before the screen capture can be confirmed from a list of programs executed just before and provided by the smart phone, and the list of programs executed just before the capture should be included in the hash value to clearly prove that the captured screen is a picture directly captured by a chatting application and to confirm that the captured screen is not a screen captured by a smart phone picture editing application or other applications.

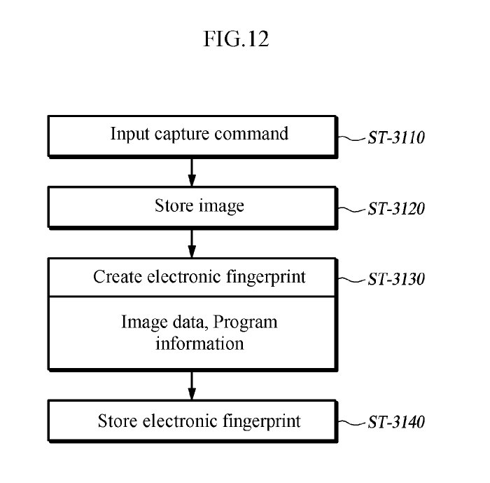

FIG. 12 is a flowchart shown to illustrate a method of storing a smart phone screen capture image. As shown in FIG. 10, the smart phone screen capture step includes the step of inputting a screen capture command by a user through the input unit (step ST-3110), a screen capture image storage step of capturing a screen and storing a captured image data in the smart phone storage unit (step ST-3120), the step of creating an electronic fingerprint (a hash value) from the screen capture image data and information on the applications executed just before the capture using a hash algorithm (step ST-3130), and a first hash value storage step of storing the electronic fingerprint in the smart phone storage unit (step ST-3140).

FIG. 11 is a screen showing a Kakao Talk picture 3111a, a Kakao Talk name 3111b and chatting content 3111c of a counterpart and chatting content 3111d of a user listed on the smart phone display unit when the user chats with the chatting counterpart. The screen capture image of the picture and the chatting content displayed on the display window used when the user chats with the chatting counterpart in the Kakao Talk application of the smart phone can be used as a digital evidence data.

If the user inputs a capture command into the input unit while the Kakao Talk screen is activated during the chatting through a Kakao Talk application as shown in FIG. 11, the captured screen image data is combined with the information on the Kakao Talk application and created as an electronic fingerprint (a hash value; a first hash value). At this point, the program executed just before is the Kakao Talk application.

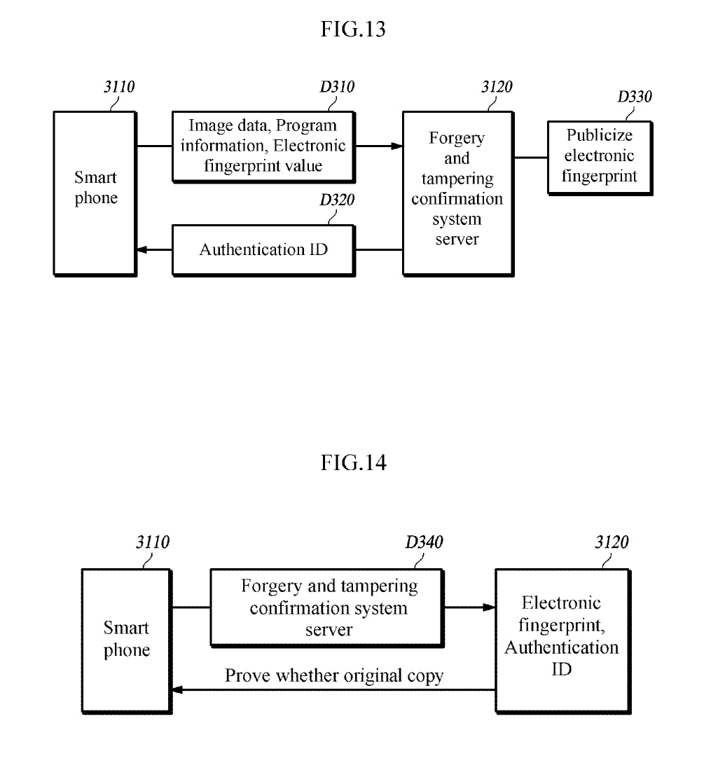

(3) As shown in FIG. 13, a first transmission step of transmitting the hash value stored in the smart phone storage unit to the forgery and tampering confirmation system server 3120 is executed. The captured screen image data (a digital data) D310 is transmitted to the forgery and tampering confirmation system server 3120, together with the electronic fingerprint (a hash value; a first hash value) calculated at step (2). Only the electronic fingerprint may be transmitted according to the condition of the network or selection of the user.

(4) Then, the forgery and tampering confirmation system server 3120 executes an authentication data storage step of creating an authentication ID by encrypting the transmitted hash value using the authentication key and storing the authentication ID, together with the hash value, in the server storage unit, and an authentication ID transmission and storage step of transmitting the authentication ID to the smart phone and storing the authentication ID in the smart phone storage unit. After the electronic fingerprint is transmitted to the forgery and tampering confirmation system server 3120, the authentication ID D320 is transmitted from the forgery and tampering confirmation system server 3120 to the smart phone as a transmission result, and the screen capture and transmission step is terminated as the smart phone 3110 receives the authentication ID D320.

In the forgery and tampering confirmation system server 3120, the electronic fingerprint (a hash value) received from the smart phone 3110 may be used later as a data for proving that the digital data is an original copy by publicizing the electronic fingerprint on an open medium (a newspaper, a homepage or the like).

In the sequence as described above, when a screen is captured, the execution program of the smart phone creates an electronic fingerprint by combining a captured screen, a list of programs executed just before the capture and the captured date and time and transmits the electronic fingerprint to the forgery and tampering confirmation system, and when forgery or tampering of a digital file is to be proved, the digital file can be authenticated by transmitting the received authentication ID and the electronic fingerprint.

The captured image authentication step includes: a second transmission step of transmitting the hash value created from the smart phone capture data image stored in the smart phone storage unit using a hash value algorithm to the forgery and tampering confirmation system server 3120, together with the authentication ID stored in the smart phone storage unit, and storing the hash value and the authentication ID in the server storage unit; and a hash value comparison step of searching for an authentication ID the same as the authentication ID received from the smart phone from the server storage unit and comparing the received hash value with the hash value stored in the server storage unit.

FIG. 14 is a view showing a process of creating an electronic fingerprint (a hash value) for authentication using information on a captured screen (a captured screen image data, a list of programs executed just before the capture, and a captured date) and transmitting a selected authentication electronic fingerprint (a hash value) and the authentication ID to a forgery and tampering confirmation system server 3120 by a smart phone application (Kakao Talk, SNS or a character message) when forgery or tampering of the image data is to be proved.

At the second transmission step, the captured image data and the execution program information are transmitted from the smart phone to the forgery and tampering confirmation system server and stored in the server storage unit, together with the hash value and the authentication ID. In the forgery and tampering confirmation system server, the received captured image data and the execution program information are created as a hash value (a second hash value) by a hash algorithm and stored in the server storage unit (a second hash value storage step); and at the hash value comparison step, the hash value transmitted from the smart phone and previously stored in the server storage unit, together with the authentication ID of a corresponding image data, is compared with the hash value (a second hash value) by the forgery and tampering confirmation unit. A result of the comparison can be transmitted to smart phone 3110 to prove that the captured image is an original copy.

According to the present invention as described above, a screen of digital data including a picture or chatting content determined to be needed is captured from a smart phone which frequently transmits and receives important personal information (pictures, chatting contents or the like) of Kakao Talk, SNS or a character message of the smart phone, and actual facts can be confirmed thereafter by proving that corresponding content is an original copy. Actually, although a digital data may lose effect as an evidence due to fine forgery or tampering, it can be used as a digital evidence in a criminal investigation or a dispute between individuals or enterprises by proving through the proposed system that the digital data is not forged or tampered.

According to the present invention as described above, a screen of digital data including a picture or chatting content determined to be needed is captured from a smart phone which frequently transmits and receives important personal information (pictures, chatting contents or the like) of Kakao Talk, SNS or a character message of the smart phone, and thereafter, actual facts can be confirmed by proving that corresponding content is an original copy. Actually, although a digital data may lose effect as an evidence due to fine forgery or tampering, it can be used as a digital evidence in a criminal investigation or a dispute between individuals or enterprises by proving through the proposed system that the digital data is not forged or tampered.

The method of the present invention as described above may be implemented as a program and stored in a recording medium (CD-ROM, RAM, ROM, a memory card, a hard disk, an optical magnetic disk, a storage device or the like) in a form readable using software of a computer.

As described above, although it has been described with reference to preferred embodiments of the present invention, those skilled in the art may embody the present invention by diversely changing or modifying the present invention without departing from the spirit and scope of the invention disclosed in the claims described below.

As described above, although it has been described with reference to preferred embodiments of the present invention, those skilled in the art may embody the present invention by diversely changing or modifying the present invention without departing from the spirit and scope of the invention disclosed in the claims described below.

### INDUSTRIAL APPLICABILITY

According to the present invention as described above, the system and method for proving forgery and tampering of a digital file using a smart phone may clearly prove whether a digital file photographed or recorded as a digital evidence is forged or tampered after the digital file is created. Actually, although the digital file may lose effect as an evidence due to fine forgery or tampering, it also can be used in the digital forensic field, a criminal investigation or a dispute between individuals or enterprises by proving that the digital file is not forged or tampered through the proposed forgery and tampering confirmation system.

In addition, the digital file can be used as a means for substituting for a notary fee, a notary problem or the like which may occur in making a contract and also can be used as a data for proving a situation in case of being involved in an incident or an accident, a data for proving foundation works after construction of a building, or a clear evidence data for a voice file in a threatening case.

In addition, in the digital information authentication system through smart phone screen capture, if a smart phone captures a screen of content determined as needed while frequently transmitting and receiving important personal information using Kakao Talk, SNS or a character message, a digital data is stored, and a list of applications executed just before the capture is also converted and stored as a hash value, and thus actual facts can be confirmed thereafter by proving that the corresponding content is an original copy. According to the digital information authentication system through smart phone screen capture and a method thereof according to the present invention, since it can be clearly proved that the image is captured from a screen of an application executed just before the capture, the system and method may be used to fundamentally prevent forgery and tampering of the captured image.

1. A system for proving forgery and tampering of a digital file using a smart phone, the system comprising:
at least one or more target terminals provided with a client program for transmitting a photographed and/or recorded digital file, a primary electronic fingerprint (a hash value) of the digital file, terminal information, position information at a time of digital file creation, meta data and a user key (key1) and receiving an authentication ID in response thereto; and
a forgery and tampering confirmation system for converting and storing the received information except the user key (key1) (the digital file, the primary electronic fingerprint, the terminal information, the position information at the time of file creation and the meta data) in a DB form, issuing and storing the authentication ID by creating a secondary electronic fingerprint (a hash value) by combining the information converted in a DB form with a manager key (key2), transmitting the authentication ID to the clients of the at least one or more target terminals, receiving a digital file of which forgery or tampering is desired to be confirmed, the authentication ID, the primary electronic fingerprint and the terminal information from the client of the target terminal when forgery or tampering of the digital file is to be proved, determining forgery or tampering of the digital file by comparing the received information with an authentication ID, an electronic fingerprint and terminal information stored in a database, and transmitting a result of determining forgery or tampering of the digital file to the client of the target terminal.

2. The system according to claim 1, wherein when forgery or tampering of the digital file is to be proved, the forgery and tampering confirmation system receives the digital file of which forgery or tampering is desired to be confirmed, the authentication ID, the primary electronic fingerprint and the terminal information from the client of the target terminal, primarily confirms whether the received primary electronic fingerprint accords to a primary electronic fingerprint recorded in the DB by searching for stored information using the authentication ID and comparing the electronic fingerprints, creates the secondary electronic fingerprint using the information received when confirmation of forgery and tampering is requested and the manager key (key2) and stores the secondary electronic fingerprint in the DB, compares the secondary electronic fingerprint with a previously publicized secondary electronic fingerprint, finally determines that the digital file is not forged or tampered if the secondary electronic fingerprint accords to the previously publicized secondary electronic fingerprint, and transmits a result of determining forgery or tampering of the digital file, the terminal information, the photographed date, the position information at a time of registration and meta data information to the client of the target terminal.

3. The system according to claim 1, wherein the forgery and tampering confirmation system includes:
a digital file input unit for receiving the photographed and/or recorded digital file, the primary electronic fingerprint (a hash value) of the digital file, the terminal information (a cellular phone number), the position information at the time of file creation, the meta data and the user key (key1) from the client of the target terminal;
a secondary electronic fingerprint creation and authentication ID issuance unit for converting the received information except the user key (key1) (the photographed and/or recorded digital file, the primary electronic fingerprint, the terminal information, the position information at the time of digital file creation and the meta data) into DB fields, issuing the authentication ID by recalculating the secondary electronic fingerprint (a hash value) using the information converted into DB fields and the manager key (key2), and transmitting the authentication ID to the client of the target terminal;
a digital file storage unit for storing the photographed and/or recorded digital file, the primary electronic fingerprint (a hash value) of the digital file, the terminal information (a cellular phone number), the position information at the time of file creation, the meta data, the secondary electronic fingerprint and the authentication ID;
a forgery and tampering determination unit for determining forgery or tampering of a corresponding digital file by confirming the authentication ID, the primary electronic fingerprint and the terminal information received from the client of the target terminal when forgery or tampering of the digital file is to be proved, and transmitting the digital file stored in the DB and the position information at the time of file creation to the client of the target terminal, together with a result of determining forgery or tampering of the digital file;
a member database; and
a database for storing the photographed and/or recorded digital file transmitted from the client of the target terminal, the primary electronic fingerprint (a hash value) of the digital file, the terminal information (a cellular phone number), the position information at the time of file creation, the meta data, the secondary electronic fingerprint and the authentication ID.

4. The system according to claim 1, wherein the photographed and/or recorded digital file is a photographed picture or moving image or a recorded voice file for proving a status of conclusion of a contract among at least two or more contract parties.

5. The system according to claim 1, wherein the meta data includes a file name, a content type, information on transmission date and time of the digital file and information on a copyright holder.

6. The system according to claim 1, wherein the primary electronic fingerprint and the secondary electronic fingerprint (hash values) are created from the user key (key1) and the manager key (key2) using a MD-5 or SHA-1 hash algorithm.

7. The system according to claim 1, wherein the authentication ID is stored in both of the target terminal and the forgery and tampering confirmation system, whereas the authentication ID, the digital file and the first electronic fingerprint are stored in the target terminal, and the authentication ID, the digital file, the first electronic fingerprint, the second electronic fingerprint, the terminal information, the meta data (e.g., file registration date and time) and the key values are stored in the forgery and tampering confirmation system.

8. A method of proving forgery and tampering of a digital file using a smart phone, the method comprising the steps of:
(a) receiving a photographed and/or recorded digital file, a primary electronic fingerprint (a hash value) of the digital file, terminal information, position information at a time of file creation, meta data and a user key (key1) from a client of at least one or more target terminals, by a forgery and tampering confirmation system;
(b) converting and storing the received information except the user key (key1) in a database, issuing and storing an authentication ID by recalculating a secondary electronic fingerprint (a hash value) by combining the information converted in a DB form with a manager key (key2), and transmitting the authentication ID to the client of the at least one or more target terminals, by the forgery and tampering confirmation system;
(c) when forgery or tampering of a digital file is to be proved, receiving the authentication ID, the primary electronic fingerprint of the digital file of which forgery or tampering is desired to be confirmed, and the terminal information from the client of the target terminal, by the forgery and tampering confirmation system; and
(d) determining forgery or tampering of the corresponding digital file by comparing the authentication ID, the primary electronic fingerprint and the terminal information with the primary electronic fingerprint stored in the database and transmitting a result of determining forgery or tampering of the digital file to the client of the target terminal, by the forgery and tampering confirmation system.

9. The method according to claim 8, wherein at step (b), the photographed and/or recorded digital file transmitted from the client of the target terminal, the primary electronic fingerprint (a hash value) of the digital file, the terminal information (a cellular phone number), the position information at the time of digital file creation, information on transmission date and time of the digital file, the secondary electronic fingerprint and the authentication ID are stored in the database of the forgery and tampering confirmation system.

10. The method according to claim 8, wherein after the information is stored in the forgery and tampering confirmation system, the authentication ID, the digital file and the primary electronic fingerprint are stored and kept in the target terminals of contract parties through wired or wireless communication or short range communication (Bluetooth or ZigBee).

11. The method according to claim 8, wherein the primary electronic fingerprint and the secondary electronic fingerprint (hash values) are created from the user key (key1) and the manager key (key2) using a MD-5 or SHA-1 hash algorithm.

12. The method according to claim 8, wherein since the client of the target terminal creates the first electronic fingerprint of the digital file from the user key (key1) and the forgery and tampering confirmation system recalculates the second electronic fingerprint using the manager key (key2), a double hash value is applied.

13. The method according to claim 8, further comprising, when forgery or tampering of the digital file is to be proved, the steps of:
receiving the digital file of which forgery or tampering is desired to be confirmed, the authentication ID, the primary electronic fingerprint and the terminal information from the client of the target terminal;
primarily confirming whether the received primary electronic fingerprint accords to a primary electronic fingerprint recorded in the DB by searching for stored information using the authentication ID and comparing the electronic fingerprints;
creating a secondary electronic fingerprint using the information received when confirmation of forgery and tampering is requested and the manager key (key2);
comparing the secondary electronic fingerprint with a previously publicized secondary electronic fingerprint;
finally determining that the digital file is not forged or tampered if the secondary electronic fingerprint accords to the previously publicized secondary electronic fingerprint; and
transmitting a result of determining forgery or tampering of the digital file, the terminal information, a photographed date, the position information at a time of registration and meta data information to the client of the target terminal, by the forgery and tampering confirmation system.

14. The method according to claim 7, further comprising the step of (e) preventing, after transmitting the authentication ID to the target terminal, manipulation of the digital file in the system in a future by publicizing the authentication ID, the digital file, the primary electronic fingerprint, information on transmission date and time of the digital file, the terminal information, the position information at the time of file creation and the secondary electronic fingerprint created using the manager key on an open webpage or using a #mail.

15. A smart phone having a function of authenticating a smart phone screen capture image, the smart phone comprising:
a control unit;
a smart phone storage unit connected to the control unit;
a display unit connected to the control unit; and
an input means connected to the control unit, wherein
a hash algorithm and one or more applications are stored and driven in the smart phone storage unit, and if a screen capture command is input by a user through the input unit, a screen is captured and stored in the smart phone storage unit as an image, and an image data is created as a hash value by a hash algorithm and stored in the smart phone storage unit.

16. The smart phone according to claim 15, wherein the image data is created as a hash value (an electronic fingerprint), together with execution program information, by a hash algorithm and stored in the smart phone storage unit.

17. The smart phone according to claim 15, wherein if the screen capture command of the smart phone is input by the user, information on screen capture date and time is captured and stored in the smart phone storage unit, together with the stored image data, and the screen capture date and time is also created as a hash value, together with the execution program information and the image data, by the hash algorithm and stored in the smart phone storage unit when the screen is captured.

18. A method of authenticating a smart phone screen capture image, the method being executed in a forgery and tampering confirmation server configured of a smart phone and a forgery and tampering confirmation system server communicating with the smart phone to authenticate the smart phone screen capture image, wherein
the smart phone includes:
a control unit;
a smart phone storage unit connected to the control unit;
a display unit connected to the control unit; and
an input means connected to the control unit, wherein
a hash algorithm and one or more applications are stored in the smart phone storage unit, and
the forgery and tampering confirmation system server includes:
a control unit;
a server storage unit connected to the control unit; and
a forgery and tampering confirmation unit for issuing an authentication ID and confirming forgery and tampering of the smart phone screen capture image, wherein
a hash algorithm is stored and driven in the server storage unit,
the method comprising a smart phone screen capture step and a captured image authentication step, wherein
the smart phone screen capture step includes:
a capture image storage step of capturing a screen and storing a captured image data in the smart phone storage unit as a screen capture command is input by a user through the input unit;
a first hash value storage step of creating the image data as a hash value using a hash algorithm and storing the hash value in the smart phone storage unit;
a first transmission step of transmitting the hash value stored in the smart phone storage unit to the forgery and tampering confirmation system server;
an authentication data storage step of creating an authentication ID by encrypting the transmitted hash value using an authentication key and storing the authentication ID in the server storage unit, together with the hash value, by the forgery and tampering confirmation system server; and
an authentication ID transmission and storage step of transmitting the authentication ID to the smart phone and storing the authentication ID in the smart phone storage unit, and
the captured image authentication step includes:
a second transmission step of transmitting the hash value created from the smart phone capture image data stored in the smart phone storage unit using a hash value algorithm to the forgery and tampering confirmation system server, together with the authentication ID stored in the smart phone storage unit, and storing the hash value and the authentication ID in the server storage unit; and
a hash value comparison step of searching for an authentication ID the same as the authentication ID received from the smart phone from the server storage unit and comparing the received hash value with the hash value stored in the server storage unit.

19. The method according to claim 18, wherein at the first hash value storage step, the image data is created as a hash value, together with execution program information, by a hash algorithm and stored in the smart phone storage unit.

20. The method according to claim 18, wherein at the capture image storage step, information on captured date and time is stored in the smart phone storage unit, together with the captured image data; and at the first hash value storage step, the information on captured date and time and execution program information are created as a hash value by a hash algorithm, together with the image data, and stored in the smart phone storage unit.

21. The method according to claim 19, wherein at the second transmission step, the captured image data and the execution program information are transmitted, together with the hash value and the authentication ID, from the smart phone to the forgery and tampering confirmation system server and stored in the server storage unit; in the forgery and tampering confirmation system server, the received captured image data and the execution program information are created as a hash value (a second hash value) by a hash algorithm and stored in the server storage unit (a second hash value storage step); and at the hash value comparison step, the hash value transmitted from the smart phone and previously stored in the server storage unit, together with the authentication ID of a corresponding image data, is compared with the hash value (a second hash value) by the forgery and tampering confirmation unit.
